(19) United States
(12) Patent Application Publication
(10) Pub. No.: US 2006/0189291 A1
(43) Pub. Date: Aug. 24, 2006

(54) Receiver and method for concurrent receiving of multiple channels

(76) Inventor: Michael Anthony Pugel, Noblesville, IN (US)

Correspondence Address: THOMSON LICENSING INC., PATENT OPERATIONS, PO BOX 5312, PRINCETON, NJ, 08543-5312, US

(21) Appl. No.: 10/548,773

(22) PCT Filed: Mar. 5, 2004
(86) PCT No.: PCT/US04/06797

§ 371 Date: Sep. 9, 2005

Related U.S. Application Data
(60) Provisional application No. 60/453,328, filed on Mar. 10, 2003.

(51) Int. Cl. H04B 1/10

(52) U.S. Cl. 455/303

(57) ABSTRACT

A signal receiving apparatus provides a flexible architecture for single or multiple channel reception capability. According to an exemplary embodiment, the signal receiving apparatus includes a front-end processor and one or more channel recovery elements. The front-end processor includes an A/D converter, a demultiplexer, and one or more filters. The A/D converter receives analog RF signals and converts the analog RF signals to digital RF signals. The demultiplexer Decimates the digital RF signals to generate decimated RF signals. The one or more filters filter the decimated RF signals to generate filtered RF signals. The one or more channel recovery elements process the filtered RF signals to provide baseband signals corresponding to one or more frequency channels.

The present invention generally relates to signal receivers, and more particularly, to an apparatus and method for receiving signals which provides a flexible architecture for single or multiple channel reception capability and enables, among other things, a lower data rate channel to be recovered from a higher data rate system.

Signal receivers, such as satellite signal receivers, may be designed to provide either single or multiple channel reception capability. With certain applications, single channel reception capability may be sufficient. For example, if cost is a paramount issue for a particular signal receiver application, it may be desirable to provide only single channel reception capability. Alternatively, there may be signal receiver applications in which multiple channel reception capability is desired. For example, multiple channel reception capability may be desirable so that multiple broadcast channels can be received simultaneously. This functionality may, for example, enable consumers to watch one channel and record another channel at the same time.

With conventional signal receivers, the respective architectures used for single and multiple channel reception capabilities tend to be quite different from one another. As a result, an architecture designed for signal receivers having only single channel reception capability may not be readily used for signal receivers having multiple channel reception capability. This incompatibility between architectures is problematic in that it may require device manufacturers to design and implement completely different and independent architectures for single channel receivers and multi-channel receivers, without benefiting from the economies of scale associated with a single architecture. The present invention addresses this problem by providing a single, flexible architecture that can be readily used for signal receivers having either single or multiple channel reception capability.

In accordance with an aspect of the present invention, a signal receiving apparatus is disclosed. According to an exemplary embodiment, the signal receiving apparatus comprises front-end processing means and channel recovering means. The front-end processing means comprises analog-to-digital (A/D) converting means, decimating means, and filtering means. The A/D converting means receive analog RF signals and convert the analog RF signals to digital RF signals. The decimating means decimate the digital RF signals to generate decimated RF signals. The filtering means filter the decimated RF signals to generate filtered RF signals. The channel recovering means process the filtered RF signals to provide baseband signals corresponding to one or more frequency channels.

In accordance with another aspect of the present invention, a method for operating a signal receiving apparatus is disclosed. According to an exemplary embodiment, the method comprises steps of receiving analog RF signals, converting the analog RF signals to digital RF signals, decimating the digital RF signals to generate decimated RF signals, filtering the decimated RF signals to generate filtered RF signals, and processing the filtered RF signals to provide baseband signals corresponding to one or more frequency channels.

The above-mentioned and other features and advantages of this invention, and the manner of attaining them, will become more apparent and the invention will be better understood by reference to the following description of embodiments of the invention taken in conjunction with the accompanying drawings, wherein:

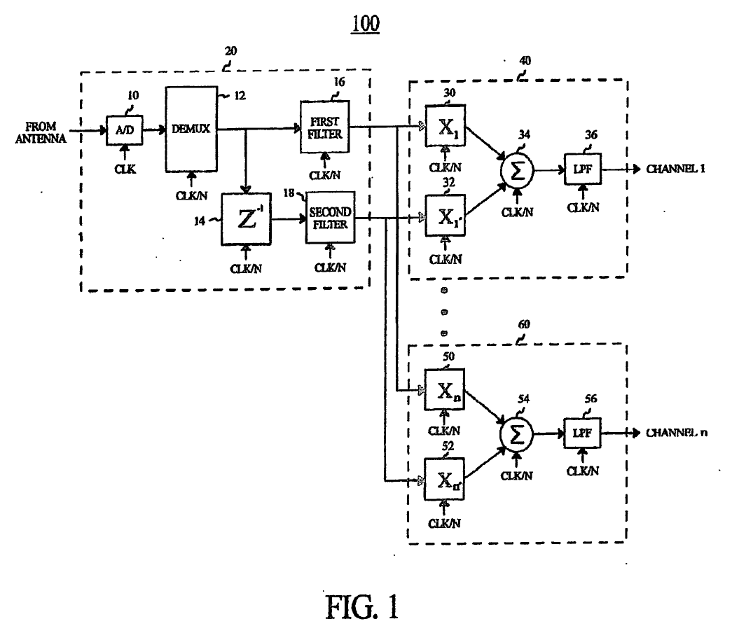

FIG. 1 is a block diagram of a signal receiving apparatus according to an exemplary embodiment of the present invention; and

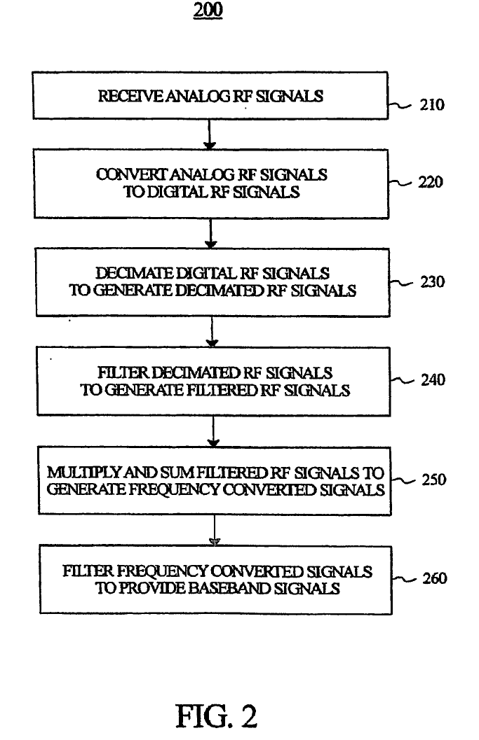

FIG. 2 is a flowchart illustrating steps according to an exemplary embodiment of the present invention.

The exemplifications set out herein illustrate preferred embodiments of the invention, and such exemplifications are not to be construed as limiting the scope of the invention in any manner.

Referring now to the drawings, and more particularly to FIG. 1, a block diagram of a signal receiving apparatus 100 according to an exemplary embodiment of the present invention is shown. In FIG. 1, signal receiving apparatus 100 comprises front-end processing means such as front-end processor 20, and channel recovering means such as channel recovery elements 40 and 60. The foregoing elements of FIG. 1 may be embodied using integrated circuits (ICs), and any given element may for example be included on one or more ICs. For clarity of description, certain conventional elements associated with signal receiving apparatus 100 such as certain control signals, power signals and/or other elements may not be shown in FIG. 1.

Front-end processor 20 is operative to perform various front-end signal processing functions of signal receiving apparatus 100. According to an exemplary embodiment, front-end processor 20 performs functions including A/D converting, signal decimating, and filtering functions. As indicated in FIG. 1, front-end processor 20 comprises A/D converting means such as A/D converter 10, signal decimating means such as demultiplexer 12, signal delay means such as delay 14, and filtering means such as first and second filters 16 and 18. The foregoing elements of front-end processor 20 may be used regardless of whether signal receiving apparatus 100 is configured for single or multiple channel reception capability. In this manner, front-end processor 20 provides a flexible architecture that can be readily used for signal receivers having either single or multiple channel reception capability.

Channel recovery elements 40 and 60 are each operative to perform functions including channel recovery functions of signal receiving apparatus 100. According to an exemplary embodiment, channel recovery elements 40 and 60 each recover and provide baseband signals corresponding to a particular frequency channel. If signal receiving apparatus 100 is receiving signals from a satellite broadcast system, for example, the baseband signals provided by each channel recovery element 40 and 60 may correspond to signals from a specific satellite transponder. Moreover, the baseband signals provided by each channel recovery element 40 and 60 may include a plurality of broadcast programs. As indicated in FIG. 1, channel recovery element 40 comprises signal multiplying means such as first and second signal multipliers 30 and 32, signal summing means such as signal summer 34, and auxiliary filtering means such as low pass filter (LPF) 36. Similarly, channel recovery element 60 comprises signal multiplying means such as first and second signal multipliers 50 and 52, signal summing means such as signal summer 54, and auxiliary filtering means such as low pass filter (LPF) 56.

For purposes of example and explanation, FIG. 1 shows two channel recovery elements 40 and 60. In practice however, the number of such channel recovery elements may vary according to design choice. For example, if multiple channel reception capability is not required, only a single channel recovery element may be used. Alternatively, if multiple channel reception capability for more than two channels is required, more than two channel recovery elements may be used. Accordingly, there may be “n” channel recovery elements where “n” is an integer.

A/D converter 10 is operative to perform an A/D converting function of signal receiving apparatus 100. According to an exemplary embodiment, A/D converter 10 receives analog radio frequency (RF) signals including audio, video, and/or data signals from one or more signal sources, such a satellite broadcast system, digital cable broadcast system, digital terrestrial broadcast system, and/or other system via a signal receiving element such as an antenna, and converts the analog RF signals to digital RF signals. The analog RF signals may for example be pre-processed (e.g., frequency converted, filtered, etc.) prior to being received by AND converter 10. Also according to an exemplary embodiment, A/D converter 10 performs the A/D converting function in accordance with a clock signal, CLK, having a frequency of 933 MHz. Other clock frequencies may also be used, including frequencies greater than 1 GHz.

Demultiplexer 12 is operative to perform a signal decimating function of signal receiving apparatus 100. According to an exemplary embodiment, demultiplexer 12 serially receives the digital RF signals provided from A/D converter 10 and demultiplexes the digital RF signals in accordance with a 1:N decimation rate (where “N” is an integer greater than one) to thereby generate decimated RF signals which are output in a parallel manner. In other words, demultiplexer 12 is clocked by a clock signal CLK/N, and thereby passes every Nth signal sample to a particular one of its N outputs. In this manner, demultiplexer 12 enables a lower data rate channel to be recovered from a higher data rate system. For example, if signal receiving apparatus 100 is receiving signals from a satellite broadcast system, demultiplexer 12 enables a lower data rate channel such as a frequency channel corresponding to one satellite transponder to be recovered from the higher data rate system comprised of multiple (e.g., 16) satellite transponders.

According to an exemplary embodiment, N is equal to 8, although other values may also be used in accordance with design choice. However, it will be intuitive to those skilled in the art that the value of N has some practical limitations. For example, if the value of N is too small, there may be a disadvantage in that signal receiving apparatus 100 must continue to perform a lot of high speed serial processing. Alternatively, if the value of N is too large, an adequate frequency response for the particular frequency channel may not be obtained.

Delay 14 is operative to perform a signal delay function of signal receiving apparatus 100. According to an exemplary embodiment, delay 14 provides a one sample delay to the decimated RF signals provided from demultiplexer 12 to thereby provide the decimated RF signals in a delayed manner. As indicated in FIG. 1, delay 14 is clocked by the clock signal, CLK/N.

First and second filters 16 and 18 are operative to perform filtering functions of signal receiving apparatus 100. According to an exemplary embodiment, first filter 16 filters the decimated RF signals provided from demultiplexer 12 to thereby generate first filtered RF signals, and second filter 18 filters the decimated RF signals having a one sample delay provided from delay 14 to thereby generate second filtered RF signals. According to this exemplary embodiment, first and second filters 16 and 18 are each clocked by the clock signal CLK/N, and each includes a number of filter taps equal to an integer multiple of N. For example, first and second filters 16 and 18 may each include N filter taps. According to this example, first and second filters 16 and 18 each constitute one half of a total filter having 2N filter taps, where the filter taps of first filter 16 constitute the first N filter taps and the filter taps of second filter 18 constitute the second N filter taps. The selection of tap values for first and second filters 16 and 18 is a matter of design choice. Although not expressly shown in FIG. 1, first and second filters 16 and 18 receive the decimated RF signals from demultiplexer 12 and delay 14, and output the first and second filtered RF signals in a parallel manner, respectively.

First and second signal multipliers 30 and 32 are operative to perform signal multiplying functions of channel recovery element 40. According to an exemplary embodiment, first signal multiplier 30 multiplies the first filtered RF signals provided from first filter 16 with consecutive sine and cosine rotational values to thereby generate first multiplied signals having in-phase (I) and quadrature (Q) components, respectively. Also according to an exemplary embodiment, second signal multiplier 32 multiplies the second filtered RF signals provided from second filter 18 with consecutive cosine and sine rotational values to thereby generate second multiplied signals having I and Q components, respectively. The number of sine and cosine rotational values used by first and second signal multipliers 30 and 32 is a function of the number of filter taps provided by first and second filters 16 and 18. First and second signal multipliers 30 and 32 respectively output the first and second multiplied signals in a parallel manner in accordance with the clock signal CLK/N. The sine and cosine values used by first and second multipliers 30 and 32 may for example be implemented using a look up table.

Signal summer 34 is operative to perform signal summing functions of channel recovery element 40. According to an exemplary embodiment, signal summer 34 sums the corresponding first and second multiplied signals provided from first and second multipliers 30 and 32, respectively, to thereby generate frequency converted signals having I and Q components which are serially output in accordance with the clock signal CLK/N.

LPF 36 is operative to perform auxiliary filtering functions of channel recovery element 40. According to an exemplary embodiment, LPF 36 filters the frequency converted signals provided from signal summer 34 using a low pass filtering technique to thereby generate baseband signals corresponding to a particular frequency channel. In particular, LPF 36 eliminates signal energy in the frequency range above the particular frequency channel in order to produce an output that only contains signal energy from the particular frequency channel. As referred to herein, the term “baseband” may refer to signals that are at, or near, a baseband level. LPF 36 serially outputs the baseband signals having I and Q components in accordance the clock signal CLK/N. As previously indicated herein, if signal receiving apparatus 100 is receiving signals from a satellite broadcast system, the baseband signals output from LPF 36 may correspond to signals from a specific satellite transponder. Moreover, the baseband signals output from LPF 36 may include a plurality of broadcast programs. The baseband signals output from LPF 36 are provided for further processing such as digital demodulation, forward error correction (FEC) decoding, and transport processing.

First and second signal multipliers 50 and 52, signal summer 54, and LPF 56 of channel recovery element 60 are substantially similar to signal multipliers 30 and 32, signal summer 34, and LPF 36 of channel recovery element 40, respectively. Accordingly, for clarity of description the functions of these common elements will not be provided again and the reader may refer to the previous descriptions provided herein. However, channel recovery element 60 is operative to recover and provide baseband signals corresponding to a different frequency channel than channel recovery element 40. Accordingly, the elements of channel recovery element 60 are different in some respects than the elements of channel recovery element 40. For example, first and second signal multipliers 50 and 52 of channel recovery element 60 may use different sine and cosine rotational values than those used by first and second signal multipliers 30 and 32 of channel recovery element 40. Moreover, LPF 56 of channel recovery element 60 may use a different pass band than that used by LPF 36 of channel recovery element 40 in order to recover a different frequency channel. Such differences between channel recovery elements 40 and 60 should be intuitive to those skilled in the art. It is again noted that the present invention may use one or more channel recovery elements such as channel recovery elements 40 and 60 depending upon whether single or multiple channel reception capability is desired. Accordingly, the use of channel recovery element 60 may be optional based on design choice. However, if multiple channel reception capability is desired, as shown in FIG. 1, channel recovery elements 40 and 60 are operative to provide baseband signals corresponding to a plurality of frequency channels in a simultaneous manner.

To facilitate a better understanding of the inventive concepts of the present invention, an example will now be provided. Referring to FIG. 2, a flowchart 200 illustrating steps according to an exemplary embodiment of the present invention is shown. For purposes of example and explanation, the steps of FIG. 2 will be described with reference to signal receiving apparatus 100 of FIG. 1. The steps of FIG. 2 are merely exemplary, and are not intended to limit the present invention in any manner.

At step 210, signal receiving apparatus 100 receives analog RF signals such as audio, video, and/or data signals from one or more signal sources, such as a satellite broadcast system, digital cable broadcast system, digital terrestrial broadcast system, and/or other system via a signal receiving element such as an antenna.

At step 220, signal receiving apparatus 100 converts the analog RF signals received at step 210 to digital RF signals. According to an exemplary embodiment, A/D converter 10 converts the analog RF signals to digital RF signals at step 220 in accordance with the clock signal CLK, which may for example exhibit a frequency above or below 1 GHz. As previously indicated herein, the analog RF signals may be pre-processed (e.g., frequency converted, filtered, etc.) prior to being received by A/D converter 10.

At step 230, signal receiving apparatus 100 decimates the digital RF signals generated at step 220 to thereby generate decimated RF signals. According to an exemplary embodiment, demultiplexer 12 serially receives the digital RF signals from A/D converter 10 and demultiplexes the digital RF signals in accordance with a 1:N decimation rate to thereby generate the decimated RF signals at step 230. In this manner, demultiplexer 12 passes every Nth signal sample to a particular one of its N outputs. As previously indicated herein, the decimated RF signals are output from demultiplexer 12 in a parallel manner in accordance with the clock signal CLK/N.

At step 240, signal receiving apparatus 100 filters the decimated RF signals generated at step 230 to thereby generate filtered RF signals. According to an exemplary embodiment, first filter 16 filters the decimated RF signals provided from demultiplexer 12 to thereby generate first filtered RF signals, and second filter 18 filters the decimated RF signals having a one sample delay provided from delay 14 to thereby generate second filtered RF signals. In this manner, the first and second filtered RF signals provided from first and second filters 16 and 18, respectively, collectively represent the filtered RF signals generated at step 240. As previously indicated herein, first and second filters 16 and 18 output their respective filtered RF signals in a parallel manner in accordance with the clock signal CLK/N.

At step 250, signal receiving apparatus 100 multiplies and sums the filtered RF signals generated at step 240 to thereby generate frequency converted signals. According to an exemplary embodiment, first signal multiplier 30 multiplies the first filtered RF signals provided from first filter 16 with sine and cosine rotational values to thereby generate first multiplied signals having I and Q components, respectively. Similarly, second signal multiplier 32 multiplies the second filtered RF signals provided from second filter 18 with cosine and sine rotational values to thereby generate second multiplied signals having I and Q components, respectively. As previously indicated herein, first and second signal multipliers 30 and 32 respectively output the first and second multiplied signals in a parallel manner in accordance with the clock signal CLK/N. Signal summer 34 then sums the corresponding first and second multiplied signals provided from first and second multipliers 30 and 32, respectively, to thereby generate frequency converted signals having I and Q components at step 250, which are serially output in accordance with the clock signal CLK/N. For multiple channel reception capability, first and second signal multipliers 50 and 52, and signal summer 54 of channel recovery element 60 may also be used to multiply and sum the filtered RF signals at step 250.

At step 260, signal receiving apparatus 100 filters the frequency converted signals generated at step 250 to thereby provide baseband signals corresponding to one or more frequency channels. According to an exemplary embodiment, LPF 36 filters the frequency converted signals provided from signal summer 34 using a low pass filtering technique to thereby generate baseband signals corresponding to a particular frequency channel at step 260. As previously indicated herein, LPF 36 serially outputs the baseband signals having I and Q components in accordance the clock signal CLK/N for further processing such as digital demodulation, FEC decoding, and transport processing. For multiple channel reception capability, LPF 56 of channel recovery element 60 may also be used to filter corresponding frequency converted signals at step 260. In this manner, channel recovery elements 40 and 60 would provide baseband signals corresponding to a plurality of frequency channels in a simultaneous manner at step 260.

In FIG. 2 described above, it is noted that steps 210 to 240 are performed in the same manner regardless of whether signal receiving apparatus 100 is configured for single or multiple channel reception capability. Steps 250 and 260, on the other hand, are scalable and may be performed in a singular manner for single channel reception capability, or in a plural manner for multiple channel reception capability.

As described herein, the present invention provides an apparatus and method for receiving signals which provides a flexible architecture for single or multiple channel reception capability and enables, among other things, a lower data rate channel to be recovered from a higher data rate system. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A signal receiving apparatus, comprising:
front-end processing means including:
analog-to-digital converting means for receiving an analog RF signal having a plurality of channels and converting said analog RF signal to a digital RF signal;
means for reducing sampling rate of said digital RF signal to generate a plurality of decimated RF signals; and
means for filtering said plurality of decimated RF signals to generate a plurality of filtered RF signals; and
channel recovering means for processing said plurality of filtered RF signals to provide at least one baseband signal, each of said at least one baseband signal corresponding to a respective channel.

2. The signal receiving apparatus of claim 1, wherein said channel recovering means includes:
signal multiplying means for multiplying said filtered RF signals with rotational values to generate multiplied signals;
signal summing means for summing said multiplied signals to generate frequency converted signals; and
auxiliary filtering means for filtering said frequency converted signals to provide said baseband signals.

3. The signal receiving apparatus of claim 1, wherein:
said baseband signal corresponds to a plurality of frequency channels; and
said channel recovering means provide said baseband signals corresponding to said plurality of frequency channels in a simultaneous manner.

4. The signal receiving apparatus of claim 1, wherein each of said one or more frequency channels includes a plurality of broadcast programs.

5. The signal receiving apparatus of claim 1, wherein said baseband signal includes in-phase and quadrature components.

6. The signal receiving apparatus of claim 1, wherein each of said one or more frequency channels corresponds to a specific satellite transponder.

7. The signal receiving apparatus of claim 1, wherein said filtering means filter said decimated RF signals in a parallel manner.

8. A method for operating a signal receiving apparatus, comprising:
receiving an analog RF signal;
converting said analog RF signal to a digital RF signal;
reducing the sampling rate of said digital RF signal to generate a plurality of decimated RF signals;
filtering said plurality of decimated RF signals to generate a plurality of filtered RF signals; and
processing said plurality of filtered RF signals to provide at least one baseband signal each of said at least one baseband signal corresponding to a respective channel.

9. The method of claim 8, wherein said processing step includes:
multiplying said filtered RF signals with rotational values to generate multiplied signals;
summing said multiplied signals to generate frequency converted signals; and
filtering said frequency converted signals to provide said baseband signals.

10. The method of claim 8, wherein said baseband signal corresponds to a plurality of frequency channels and are provided in a simultaneous manner.

11. The method of claim 8, wherein each of said one or more frequency channels includes a plurality of broadcast programs.

12. The method of claim 8, wherein each of said one or more frequency channels correspond to a specific satellite transponder.

13. The method of claim 8, wherein said baseband signals include inphase and quadrature components.

14. A signal receiving apparatus, comprising:
a front-end processor including:
an analog-to-digital converter operative to receive an analog RF signal and convert said analog RF signal to a digital RF signal;
a demultiplexer operative to decimate said digital RF signal to generate a plurality of decimated RF signals; and
one or more filters operative to filter said plurality of decimated RF signals to generate a plurality of filtered RF signals; and
one or more channel recovery elements operative to process said plurality of filtered RF signals to provide at least one baseband signal corresponding to a respective channel.

15. The signal receiving apparatus of claim 14, wherein each said channel recovery element includes:
one or more signal multipliers operative to multiply said filtered RF signals with rotational values to generate multiplied signals;
a signal summer operative to sum said multiplied signals to generate frequency converted signals; and
an auxiliary filter operative to filter said frequency converted signals to provide said baseband signals.

16. The signal receiving apparatus of claim 14, wherein:
said one or more channel recovery elements include a plurality of channel recovery elements; and
said plurality of channel recovery elements provide said baseband signals corresponding to a plurality of frequency channels in a simultaneous manner.

17. The signal receiving apparatus of claim 14, wherein each of said one or more frequency channels includes a plurality of broadcast programs.

18. The signal receiving apparatus of claim 14, wherein said baseband signals include in-phase and quadrature components.

19. The signal receiving apparatus of claim 14, wherein each of said one or more frequency channels corresponds to a specific satellite transponder.

20. The signal receiving apparatus of claim 14, wherein said one or more filters filter said decimated RF signals in a parallel manner.

21. The signal receiving apparatus of claim 1, wherein said filtering means preserves only the spectrum reserved to a desired channel.
